(19) United States
(12) Patent Application Publication
(10) Pub. No.: US 2006/0168598 A1
(43) Pub. Date: Jul. 27, 2006

(54) Disk drive equipped with tray

(76) Inventors: Masahiko Nishide, Fukui (JP); Takeshi Makino, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/336,782

(22) Filed: Jan. 23, 2006

(30) Foreign Application Priority Data
Jan. 25, 2005 (JP) 2005-16745

(51) Int. Cl. G11B 17/04; G11B 17/03; G11B 33/02

(52) U.S. Cl. 720/603

(57) ABSTRACT

To provide a disk drive that automatically causes a disk set in a tray to be set in a recessed portion of the tray when the tray is retracted into the drive if the disk is off-center and not properly set in the recessed portion, a disk placement recessed portion having a pair of roughly semicircular outer rims is formed on the top surface of the tray, the outer rims of the recessed portion having a support surface that the lower surface of the disk near the edge of the disk contacts and an inner rim surface that the disk edge contacts so as to position the disk, the support surface formed at a location higher than that of the bottom surface of the recessed portion, with inclined surfaces continuous with the bottom surface of the recessed portion formed at both ends of the support surface.

### BACKGROUND OF THE INVENTION

1. Field of the Invention

The present invention relates to a disk drive equipped with a tray, and more particularly, to a disk drive in which a disk placed out of position on the tray can be automatically positioned at a predetermined position.

2. Related Art

In a disk drive equipped with a tray, the tray is mounted so as to travel reciprocally between a disk removal position and a disk reproduction position, such that, when setting a disk on the tray, as shown in FIG. 11A, a tray 1 extends fully so as to be in an open state (the disk removal position) and the tray 1, on which the disk is set, is retracted into the interior of the disk drive and transported to the disk reproduction position. Then, together with a traverse unit 2, a turntable 3 rises, lifts the disk that is set on the tray 1, and fixes the disk in place on the turntable 3 by a damper 4, in which state the disk is rotated at high speed by a motor for reproduction (see FIG. 11B).

FIGS. 10A, 10B and 10C are diagrams showing a typical tray 1 of a conventional disk drive, on a top surface of which are formed concentrically a circular recessed portion 5 that accommodates a disk having a diameter of 120 mm and a circular recessed portion 6 that accommodates a disk having a diameter of 80 mm. As shown in FIG. 10C, the circular recessed portion 5 is comprised of a bottom surface 5e and an outer rim, with the outer rim formed from an inclined surface 5a, an inner rim 5b and a support surface 5c. A level difference surface 5d is provided between the support surface 5c and the bottom surface 5e. When a 120 mm diameter disk is placed on the circular recessed portion 5, the bottom of the edge of the disk is placed on the support surface 5c, at which time the edge of the disk contacts the inner rim 5b and the disk is thereby positioned and held in place.

However, accidents do occur in which, as indicated by the imaginary line shown in FIGS. 10A and 10C, the disk D is not set properly in the circular recessed portion and yet, is transported into the drive in that state. As a result, the disk cannot be set on the rising turntable 3, and of course clamping with the damper 4 is also impossible. In such cases, there is a danger that the disk will be caught between the turntable 3 and the damper 4 and the recording surface damaged, and/or that the turntable will be damaged. In addition, if the disk is transported into the main unit of the drive in a state in which the disk protrudes from the tray 1, there is a risk that the disk will get caught in the entrance of the tray 1 and damaged. Moreover, when the disk D protrudes from the tray 1 and hits the tray entrance/exit, the edge of the disk D can catch on the level difference surface 5d and become unable to slide onto the support surface 5c.

In order to eliminate the risk of damaging the recording surface of an optical disk by contact with the disk tray, a disk device according to JP-A-2003-303462 forms a continuous downward sloping inclined surface from the outer edge to the inner edge of a disk loading area. Therefore, a disk set on the disk loading area contacts the disk tray only at the edge of the disk, and thus there is no possibility that the disk recording surface will be damaged. However, the inclined surface of the loading area does not function to position a disk set awkwardly on the support surface of the tray.

In addition, in order to set the disk properly automatically regardless of its direction of displacement, in a disk loading device according to JP-A-2004-273065 “a disk placement recessed portion provided on the top surface of the tray, approximately half the distal rim of which is made higher than approximately half the proximal rim thereof, with substantially flat planar pawls provided on the distal rim and the proximal rim so as to slant downward toward the center of the recessed portion.”

Accordingly, by providing flat planar pawls that slant toward the center of the recessed portion on the rims of the recessed portion of the tray, the disk is seated automatically in the recessed portion even if the disk is not placed properly on the tray. However, the slanted pawls provided on the periphery of the recessed portion impede the removal of the disk from the tray when the latter is transported to the disk removal position.

### SUMMARY OF THE INVENTION

Accordingly, the present invention is intended to solve the above-described problems of the conventional disk drive, and has as its object to provide a disk drive that uses an extremely simple tray form to automatically set even a disk placed off-center on the tray in the recessed portion of the tray and which also does not hinder removal of the disk.

To achieve the above-described object, the present invention provides a disk drive equipped with a retractable disk transport tray, in which a disk is set on the tray outside the drive and the tray is retracted so as to transport the disk into the interior of the drive, with the disk drive including a recessed portion formed in the tray for accommodating the disk, the recessed portion having a pair of substantially semicircular outer rims disposed opposite each other, the semicircular outer rims of the recessed portion having a support surface that the bottom surface of the disk contacts near the outer edge of the disk and an inner surface that the outer edge of the disk contacts so at to position the disk, the support surface formed at a location above the bottom surface of the recessed portion, an inclined surface continuous with the bottom surface of the recessed portion formed at both ends of the support surface. With such a structure, even a disk that is not set properly in the recessed portion of the tray by its own weight slides over the step-less bottom surface to settle automatically atop the support surface.

Preferably, the inclined surface formed at both ends of the support surface are formed so as to be lower than the bottom surface of the disk, in a state in which one edge of the disk is placed atop the tray and the other edge contacts the bottom surface of the recessed portion. With such a structure, the problem of the bottom edge of a disk that is not set properly in the recessed portion of the tray contacting the level difference surface of the outer rim of the recessed portion can be reliably avoided and an obstacle to the sliding of the disk removed.

Preferably, an opening is formed in one of the substantially semicircular outer rims of the recessed portion of the tray that cuts through the semicircular outer rim and penetrates longitudinally through the tray, in order to make the drive lightweight. In addition, preferably, a plurality of the support surfaces is formed at the same height from the bottom surface of the recessed portion, such that a disk placed on the tray is supported substantially parallel to the bottom surface of the recessed portion.

By forming inclined surfaces that are continuous with the bottom surface of the recessed portion at both ends of the support surface of the tray, the disk drive of the present invention enables a disk that is not set in the recessed portion properly to be automatically set in the recessed portion. In other words, the edge of the disk slides along the inclined surface and the disk is set easily in the recessed portion. That is, as the disk slides, the disk does not contact the level difference surface formed between the support surface and the bottom surface of the recessed portion. Therefore, a disk set in the recessed portion and transported by the tray to the disk reproduction position is placed on the turntable by the rising of the traverse unit without damage to the disk.

Other objects, features and advantages of the present invention will be apparent from the following description when taken in conjunction with the accompanying drawings, in which like reference characters designate the same or similar parts throughout the figures thereof.

### BRIEF DESCRIPTION OF THE DRAWING

FIG. 1 is a diagram showing a plan view of a tray of a disk drive according to one embodiment of the present invention;

FIG. 2 is a diagram showing a sectional view along a line 2-2 shown in FIG. 1;

FIG. 3 is a diagram showing an enlarged view of a section C shown in FIG. 2;

FIG. 4 is an enlarged perspective view of an edge portion of a surface of the tray on which a disk is set;

FIG. 5 is a plan view showing a state in which a disk is placed off-center on the tray;

FIG. 6 is a sectional view showing a state in which a disk is placed off-center on the tray

FIG. 7 is a plan view showing a disk set in a recessed portion of the tray;

FIG. 8 is a sectional view showing a disk set in the recessed portion of the tray;

FIGS. 9A and 9B are longitudinal side sectional views showing the disk drive with the tray extended and the tray retracted, respectively; and

FIGS. 10A, 10B and 10C are diagrams showing a plan view of a conventional disk drive tray, a side view of a conventional disk drive tray, and a sectional view along a line 10C-10C shown in FIG. 10A, respectively.

### DETAILED DESCRIPTION OF PREFERRED EMBODIMENT

A detailed description will now be given of a preferred embodiment of the present invention, with reference to the diagrams.

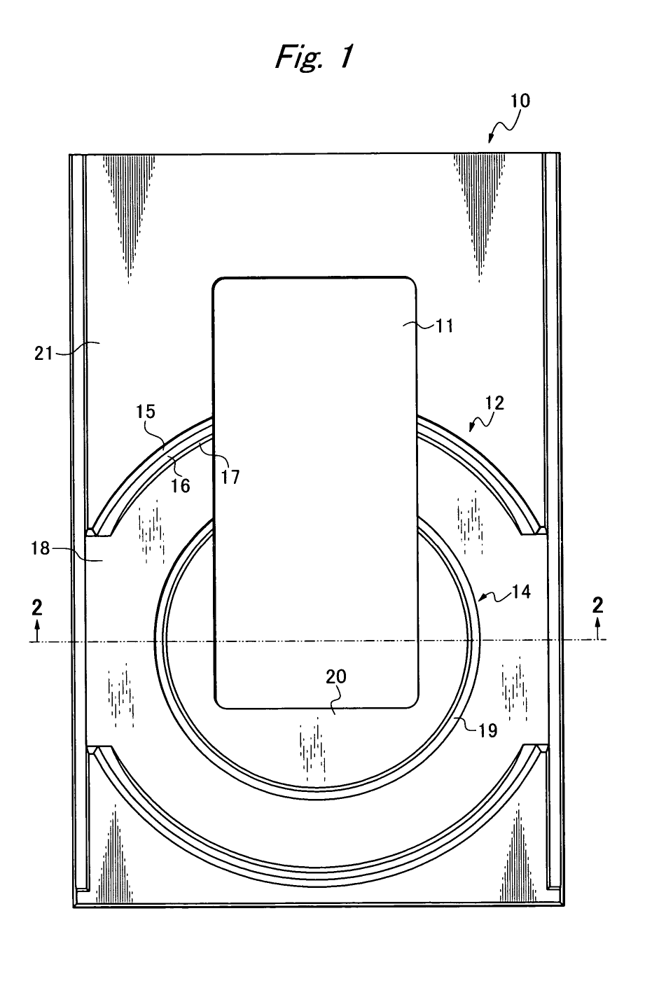

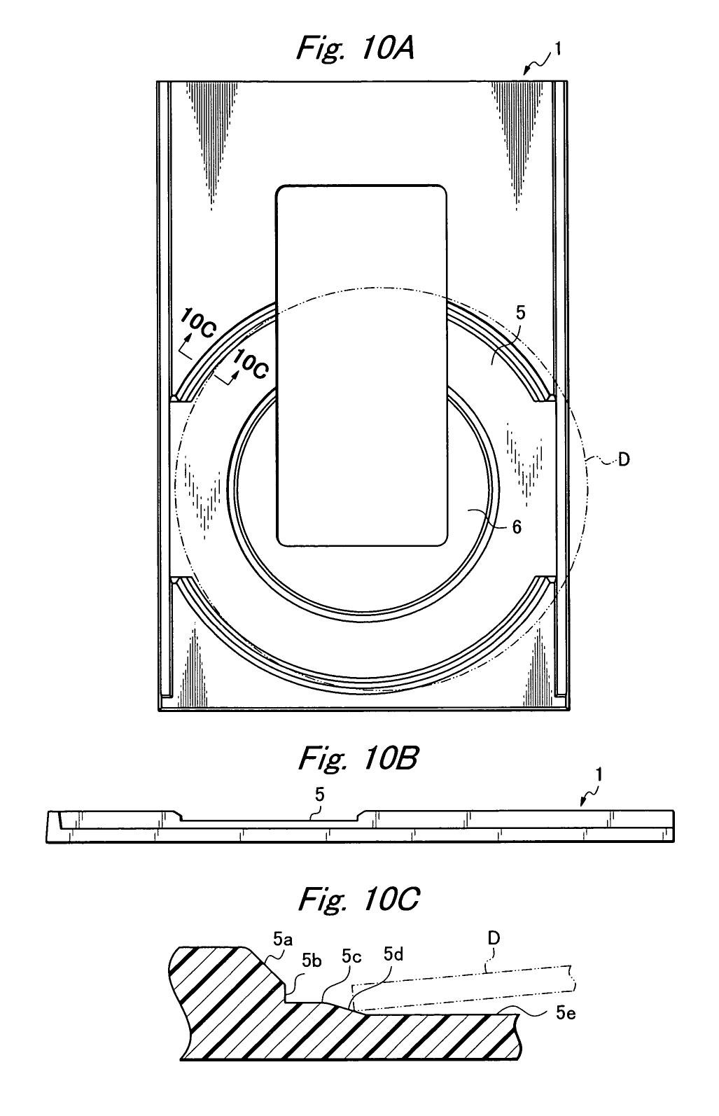

FIG. 1 shows a tray 10 attached to a disk drive according to the present invention. As can be seen therein, the tray 10 is a rectangular planar body, having a substantially rectangular opening 11 in a center portion thereof, with a circular recessed portion 12 to accommodate a disk having a diameter of 120 mm and a circular recessed portion 14 to accommodate a disk having a diameter of 80 mm. The two recessed portions are disposed concentrically. Thus, the basic form is the same as that shown in FIGS. 10A and 10B. The recessed portion 12 is formed by a pair of roughly semicircular outer rims disposed opposite each other. One such outer rim is divided laterally in two by the opening 11 formed in the center of the tray and which penetrates the tray.

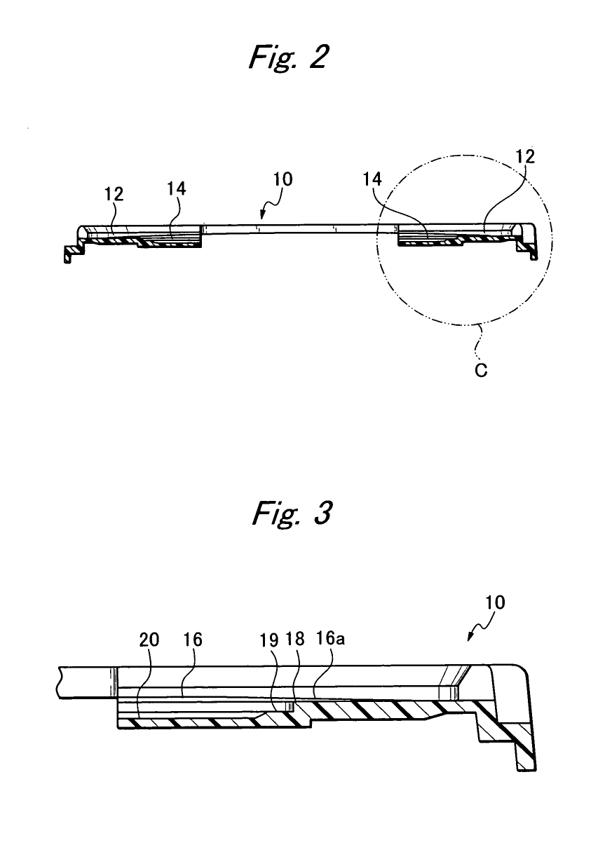

As shown in FIG. 2, the recessed portions 12 and 14 are formed unevenly to two different heights, with recessed portion 14 lower than recessed portion 12. The outer rim of recessed portion 12 is formed by a somewhat slanted inner rim surface 15, a horizontal support surface 16, and a level difference surface 17. The bottom of the edge of a disk set in the recessed portion 12 rests on the support surface 16, leaving a gap between the bottom surface of the disk and the bottom surface 18 of the recessed portion 12, such that the recording surface of the disk is not contacted. Moreover, as shown in FIG. 3, which shows an enlarged view of section C shown in FIG. 2, in the case of the recessed portion 14 as well, a support surface 19 is formed at a location that is higher than a bottom surface 20, so that the recording surface of a disk set in the recessed portion 14 also is not contacted.

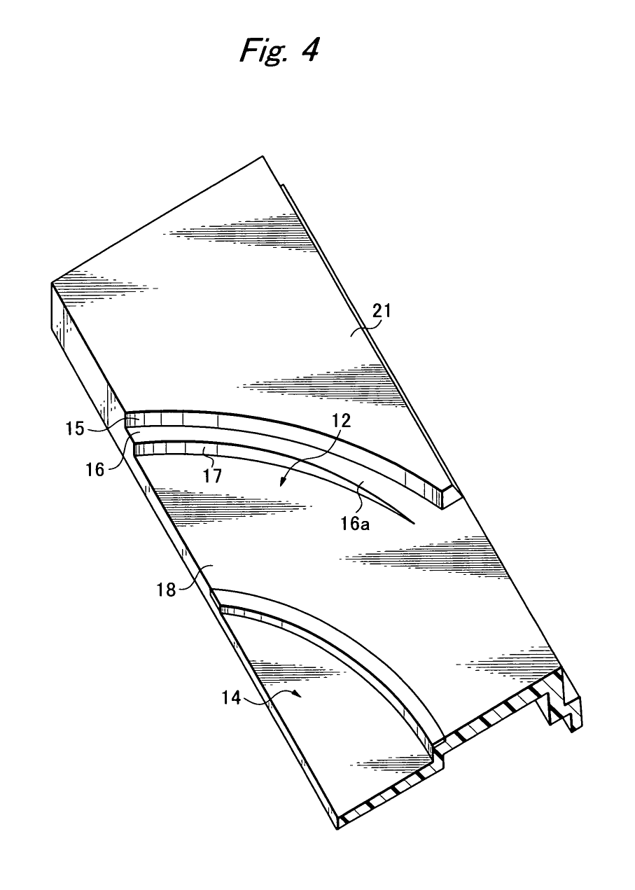

Although the support surface 16 of the recessed portion 12, as described above, is formed at a location higher than that of the bottom surface 18 through the level difference surface 17, as is dear from FIG. 4, the two end portions of the support surface 16 (only one of which is shown in FIG. 4) are not horizontal surfaces but are instead inclined surfaces 16a. In other words, the height of the level difference surface 17 gradually decreases at these ends so as to become one with the bottom surface 18. The inclined surface 16a is formed so as to be below the bottom surface of the disk in a state in which one edge of the disk rests atop the left side of the tray and the other edge of the disk contacts the bottom surface of the recessed portion. As a result, contacting the lower edge of an inclined disk that is not set properly in the recessed portion of the tray against the level difference surface 17 of the outer rim of the recessed portion can be reliably avoided. In addition, the outer rims that form the recessed portion 12 are formed by two roughly semicircular arcs, with the center of the upper arc cut through by the opening 11.

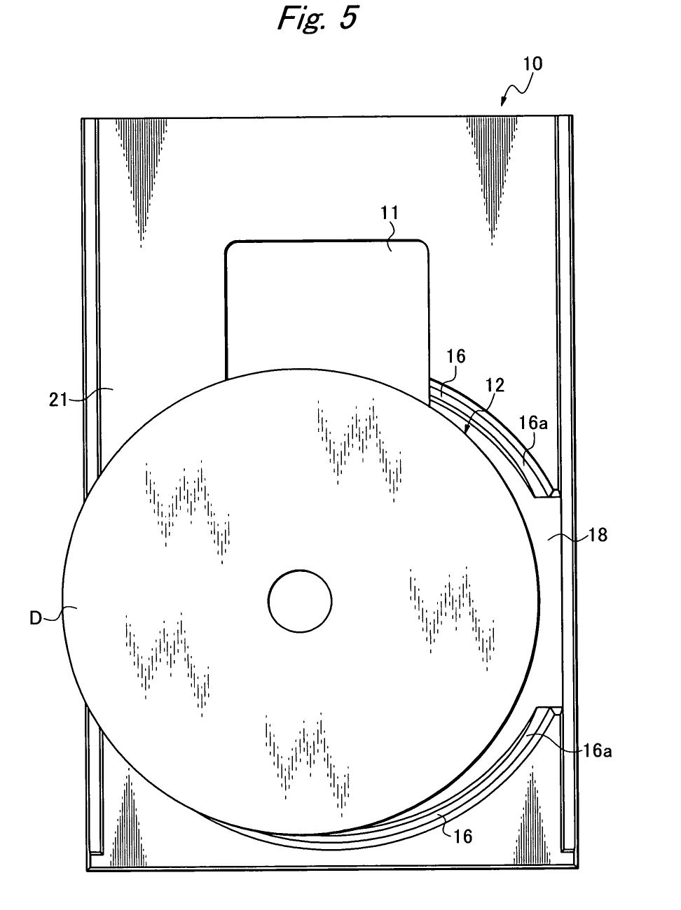

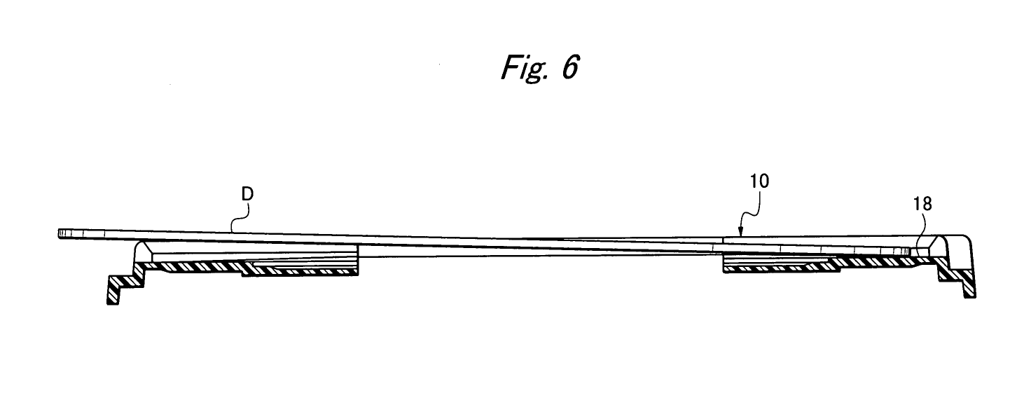

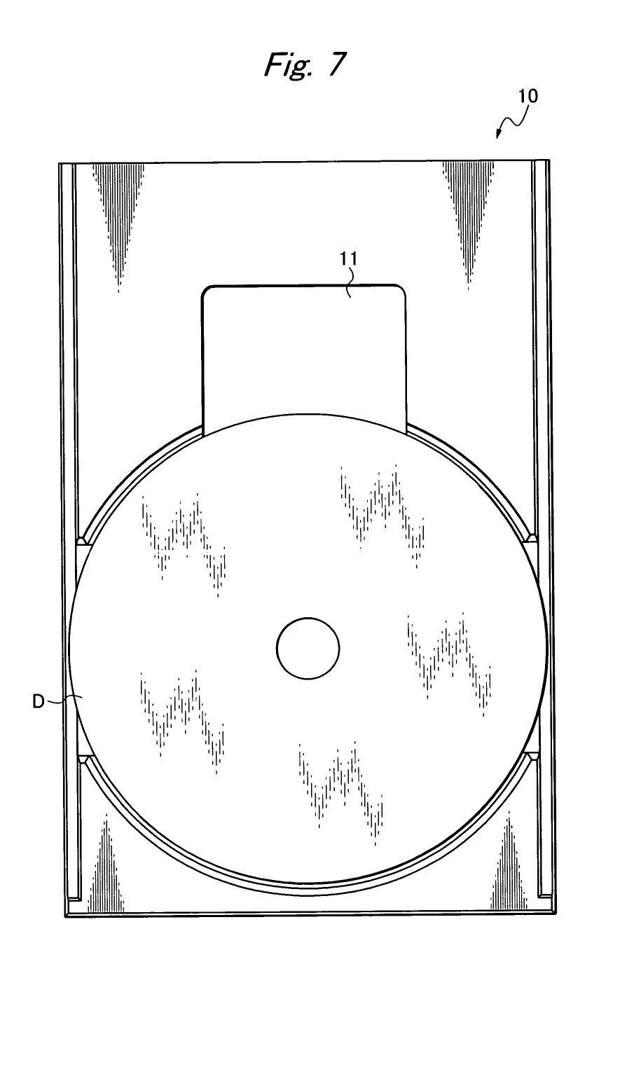

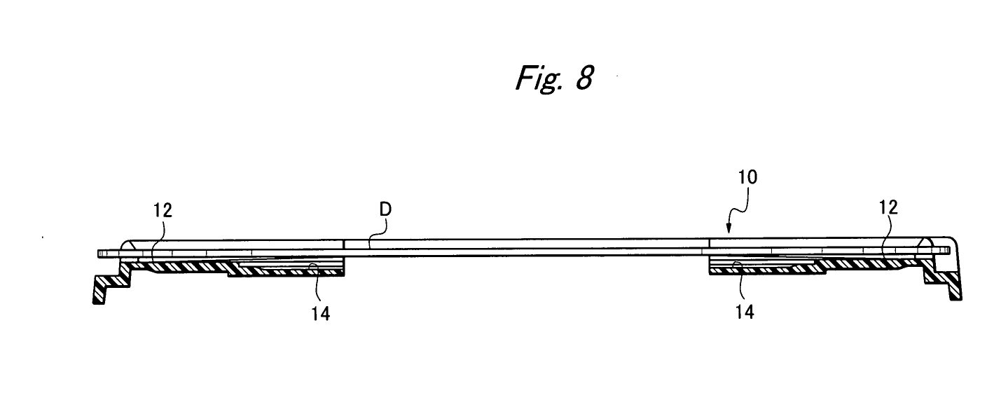

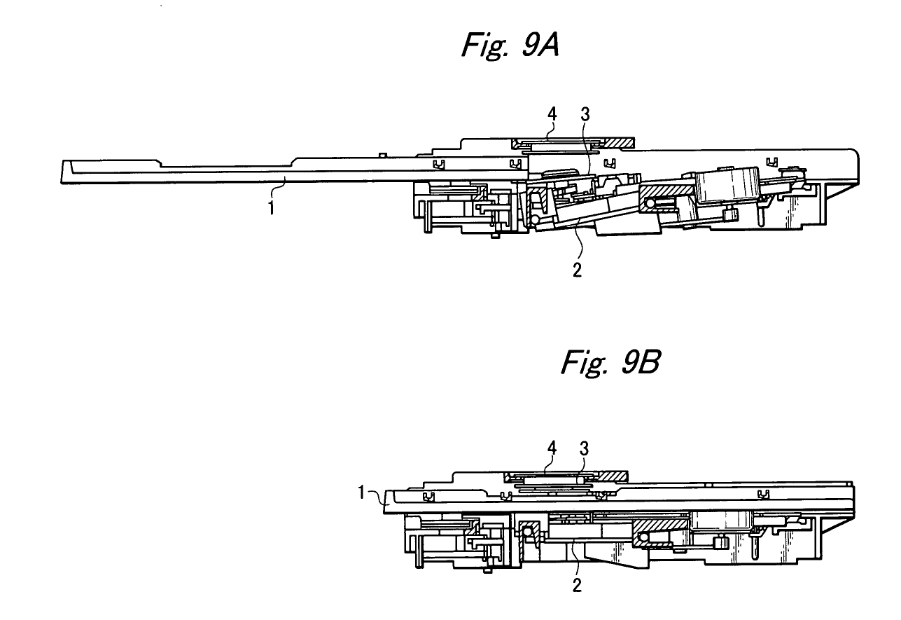

With the foregoing structure, a disk D set in the recessed portion 12 of the tray 10, for example, a disk not placed properly but offset form the center as shown in FIGS. 5 and 6, that is, with one end of the inclined disk D at the bottom surface 18 and the other end protruding from the recessed portion 12 onto the top surface 21 of the tray 10, the disk D moves automatically from this state by its own weight, sliding along the inclined surfaces 16a, 16a of the support surfaces 16, 16 so as to be seated in the recessed portion 12 and properly positioned (as shown in FIGS. 7 and 8).

In addition, even if the disk D is placed off center on the tray 10 and does not of its own weight automatically slide along the inclined surface 16a of the support surface 16, either the vibration of the tray 10 as it begins retraction into the interior of the drive or the entrance of the tray 10 contacting the protruding portion of the disk D causes the disk D to slide and be set in the recessed portion 12 and properly positioned.

Thus, as described above, by eliminating the level difference surface 17 from both ends of the support surface 16 of the tray 10, a disk D that is off center and not placed in the proper position can slide smoothly into the recessed portion 12, enabling the width of the tray 10 to be made substantially the same as the diameter of the disk and thereby allowing the disk drive to be made more lightweight and more compact.

As many apparently widely different embodiments of the present invention can be made without departing from the spirit and scope thereof, it is to be understood that the invention is not limited to the specific embodiments thereof except as defined in the appended claims.

What is claimed is:

1. A disk drive equipped with a retractable disk transport tray, in which a disk is set on the tray outside the drive and the tray is retracted so as to transport the disk into the interior of the drive,
the disk drive comprising a recessed portion formed in the tray for accommodating the disk,
the recessed portion having a pair of substantially semicircular outer rims disposed opposite each other,
the semicircular outer rims of the recessed portion having a support surface that the bottom surface of the disk contacts near the outer edge of the disk and an inner surface that the outer edge of the disk contacts so at to position the disk,
the support surface formed at a location above the bottom surface of the recessed portion,
an inclined surface continuous with the bottom surface of the recessed portion formed at both ends of the support surface.

2. The disk drive according to claim 1, wherein the inclined surface formed at both ends of the support surface are formed so as to be lower than the bottom surface of the disk in a state in which one edge of the disk is placed atop the tray and the other edge contacts the bottom surface of the recessed portion.

3. The disk drive according to claim 2, wherein an opening is formed in one of the substantially semicircular outer rims of the recessed portion of the tray that cuts through the semicircular outer rim and penetrates longitudinally through the tray.

4. The disk drive according to claim 2, wherein a plurality of the support surfaces is formed at the same height from the bottom surface of the recessed portion, such that a disk placed on the tray is supported substantially parallel to the bottom surface of the recessed portion.
